(19) United States
(12) Patent Application Publication
(10) Pub. No.: US 2013/0073510 A1
(43) Pub. Date: Mar. 21, 2013

(54) Method for automatically retrieving and analyzing multiple groups of documents by mining many-to-many relationships

(71) Applicant: GANG QIU, CUPERTION, CA (US)

(72) Inventor: GANG QIU, CUPERTION, CA (US)

(21) Appl. No.: 13/622,401

(22) Filed: Sep. 19, 2012

(30) Foreign Application Priority Data
Sep. 19, 2011 (CN) CN201110277690.1

(51) Int. Cl. G06N 5/02

(52) U.S. Cl. 706/55; 706/46

(57) ABSTRACT

A method for automatically retrieving and analyzing multiple groups of documents by mining many-to-many relationships: (1) inputting first retrieval condition and retrieving first result set A; (2) inputting second retrieval condition and retrieving second result set B; (3) inputting at least one or pluralities of matching conditions for the first result set A and the second result set B; (4) obtaining at least one or pluralities of matched pairs, wherein the matched pairs Mₘₙ=(Aₘ, Bₙ) comprise of the first document Aₘ from the first result set A, and the second document Bₙ from the second result set B and Aₘ and Bₙ satisfy the matching conditions, and collecting sets of documents from the matched pairs Mₘₙ as A^{T}, B^{T}, wherein A^{T}={Aₘ, AₘεMₘ._{,}}, B^{T}={Bₙ, BₙεM.ₙ}, AₘεA^{T} [symbol] A, BₙεB^{T} [symbol] B; (5) analyzing A^{T}, B^{T} combined or separated and obtaining the results.

### TECHNICAL FIELD

The present invention relates to a method and system for automatically retrieving and analyzing multiple groups of documents by mining many-to-many relationships, and particularly to a method and system for automatically retrieving and analyzing multiple groups of documents by using semantic retrieval technology to mine many-to-many relationships.

### BACKGROUND OF THE INVENTION

The development of semantic technology makes automatic document retrieval possible. By inputting a target document, based on the semantic relevance between the target document and multiple other documents, the technology automatically retrieves the documents that are semantically relevant to the target document.

However, there is no technology available for automatically retrieving and analyzing multiple groups of documents based on many-to-many relationships. Only available solution is to analyze multiple groups of documents with isolated and single-sided methods without considering any of relevant relationships, as shown in FIG. 1.

Generally, the relationships between one group of documents vs. another group of documents needs to be defined and analyzed. For example, we know Microsoft is fiercely competing against Apple in all relevant technology fields. This fierce, head-to-head competition is encoded in many-to-many relevant (competing) relationships between two groups of patent documents. These many-to-many relationships are implicit instead of explicit. By mining these implicit relationships based on the relevance degree, it connect, otherwise relationship-less, multiple groups of documents in a content-relevant way and makes the further related analysis possible. In current art of fields, that rich many-to-many relationships for multiple groups of documents are lost and never explored.

In order to fully understand the competing relationship between Microsoft company patent documents (set A) and Apple company patent documents (set B), an inventive analysis is needed for exploring and mining many-to-many relationships between two groups of patent documents. For example, a relationship to be explored in this many-to-many analysis setting is whether a subset of documents A^{S} from Microsoft company patent documents set A is relevant to (competing against) a subset of documents B^{S} from Apple company patent documents set B. Furthermore, If A^{S} and B^{S} are relevant (competing), then what is the role the two groups of relevant (competing) documents are playing—leading or lagging of the invention date or patent application date for the relevant patent documents. Moreover, what is the degree of technologies sophistication two companies are have with respect to each other—for example, in this many-to-many analysis setting, in the majority of matched cases, a group of patents documents from one company are always applied earlier than another group of patents documents from another company, which may indicate technologies mastered by one company are more advanced than those from another company.

### BRIEF SUMMARY OF THE INVENTION

Therefore, it is an object of the present invention to automatically retrieve and analyze multiple groups of documents by mining many-to-many relationships;

It is another object of the present invention to automatically identify many-to-many relevant (competing) relationships among multiple groups of documents.

The present invention provides a method for automatically retrieving and analyzing multiple groups of documents by mining many-to-many relationships,

step 1, inputting first retrieval condition, and retrieving first result set A;

step 2, inputting second retrieval condition and retrieving second result set B;
Step 3, inputting at least one or pluralities of matching conditions for the first result set A and the second result set B;
Step 4, based on the first result set A and the second result set B, and at least one or pluralities of matching conditions for the first result set A and the second result set B, obtaining at least one or pluralities of matched pairs Mₘₙ=(Aₘ, Bₙ), wherein the matched pairs Mₘₙ=(Aₘ, Bₙ) comprise of the first document Aₘ and the second document Bₙ, wherein the first document Aₘ is from the first result set A, and the second document Bₙ is from the second result set B, and Aₘ and Bₙ satisfying the matching conditions and collecting documents from the matched pairs Mₘₙ as A^{T}, B^{T}, wherein A^{T}={Aₘ, AₘεMₘ._{,}}, B^{T}={Bₙ, BₙεM.ₙ}, AₘεA^{T} [symbol] A, BₙεB^{T} [symbol] B;
Step 5, analyzing A^{T}, B^{T} combined or separated, and obtaining the results.

The present invention also provides a system for automatically retrieving and analyzing multiple groups of documents by mining many-to-many relationships, comprising:

a device for inputting first retrieval condition and retrieving first result A;
a device for inputting second retrieval condition and retrieving second result set B;
a device for inputting at least one or pluralities of matching conditions for the first result set A and the second result set B, wherein the matching relationship is the semantic relevance threshold Rₜ, wherein the semantics relevance threshold Rₜ is the minimum relevance degree that match the first document Aₘ from the first result set A with the second document Bₙ from the second result set B,

Rel(Aₘ,Bₙ)>=Rₜ (3)

a device for obtaining at least one or pluralities of matched pairs Mₘₙ=(Aₘ, Bₙ) that based on the first result set A and the second result set B, and at least one or pluralities of the matching conditions, wherein the matched pairs Mₘₙ=(Aₘ, Bₙ) comprising first document Aₘ and second document Bₙ, wherein the first document Aₘ from the first result set A, and the second document Bₙ from the second result set B and collecting sets of documents from the matched pairs Mₘₙ as A^{T}, B^{T}, wherein A^{T}={Aₘ, AₘεMₘ._{,}}, B^{T}={Bₙ, BₙεM.ₙ}, AₘεA^{T} [symbol] A, BₙεB^{T} [symbol] B;
a device for analyzing A^{T}, B^{T} combined or separated, obtaining the results.

### DESCRIPTION OF THE FIGURES

The above and other objectives, features and advantages of the present invention will be more apparent through the more detailed description with reference to the accompanying drawings of the present invention.

FIG. 1 is an existing technology applied to analyze two groups of documents with isolated, single-sided methods in comparison to the present invention which automatically retrieve and analyze two groups of documents by mining many-to-many relationships.

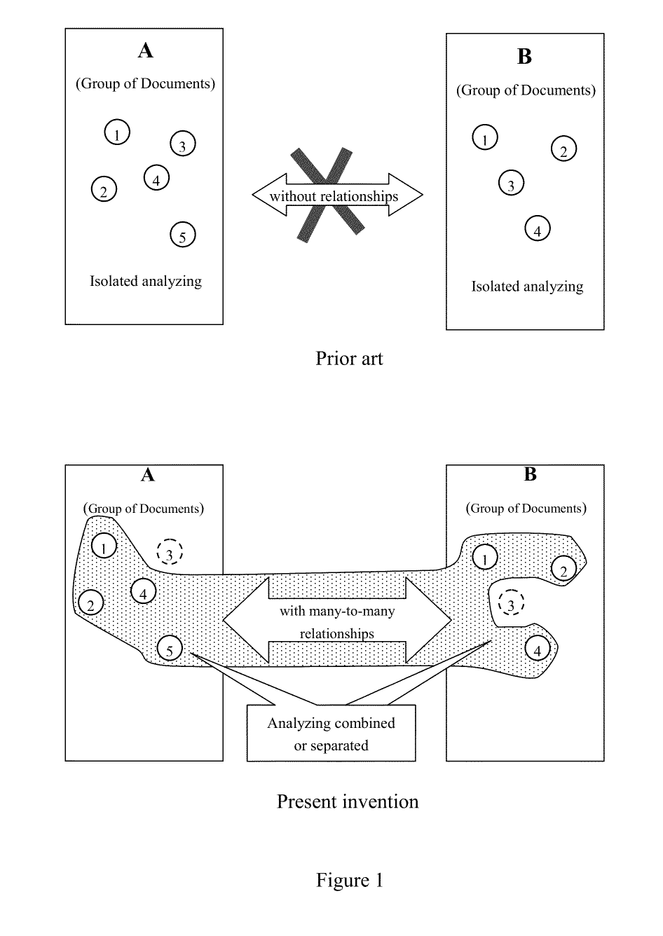

FIG. 2 is a flowchart of the first embodiment based on the present invention, comprising of the process for automatically retrieving and analyzing multiple groups of documents by mining many-to-many relationships.

FIG. 3 is a flowchart of the second embodiment based on the present invention, comprising of a preferred process for automatically retrieving and analyzing multiple groups of documents by mining many-to-many relationships.

FIG. 4 is a flowchart of the third embodiment based on the present invention, comprising another preferred process for automatically retrieving and analyzing multiple groups of documents by mining many-to-many relationships.

FIG. 5 is a preferred process of the step 5 based on the embodiment 1, 3 of the present invention.

FIG. 6 is a specific application case for calculating semantic relevance degree between any one document from group A of documents and any one document from group B of documents.

FIG. 7 is a matching condition used in the embodiment of the present invention.

FIG. 8 is another matching condition used in the embodiment of the present invention.

FIG. 9 is a system output based on the embodiment of the present invention.

### DETAILED DESCRIPTION

### 1. Document

The document is a medium that records human knowledge or understanding by using text, graphics, symbols, audio, video and other means. It is a general term for recording, accumulating, communicating and transferring of knowledge.

In addition to recording content, a document consists of other attributes, such as author (inventor)'s name, applicant (assignee)'s name, application date, publication date, applicant's addresses and so on.

### 2. Semantic Retrieval

Semantic retrieval is a new class of information retrieval method that has been developed based on existing technology. What makes semantic retrieval different from other information retrieval methods, is that semantic retrieval places emphasis on meaning and concept instead of mechanical matches to literal words and phrases. Semantic retrieval improves retrieval precision and recall, which in turn reduces the burden of search on the user.

### 3. Boolean Retrieval

Boolean retrieval is the basic method used in information retrieval with 175 logical “or” (+, OR), logical “and” (x, AND), logical “not” (˜, NOT) and other operators.

Logical “or” (+, OR): whenever a document contains one or more of its operands, that document is defined as a hit document.

Logical “and” (*, AND): whenever a document contains all of the operands, that document is defined as a hit document.

Logical “not” (˜, NOT): whenever a document does not contain one of its operand, that document is defined as a hit document.

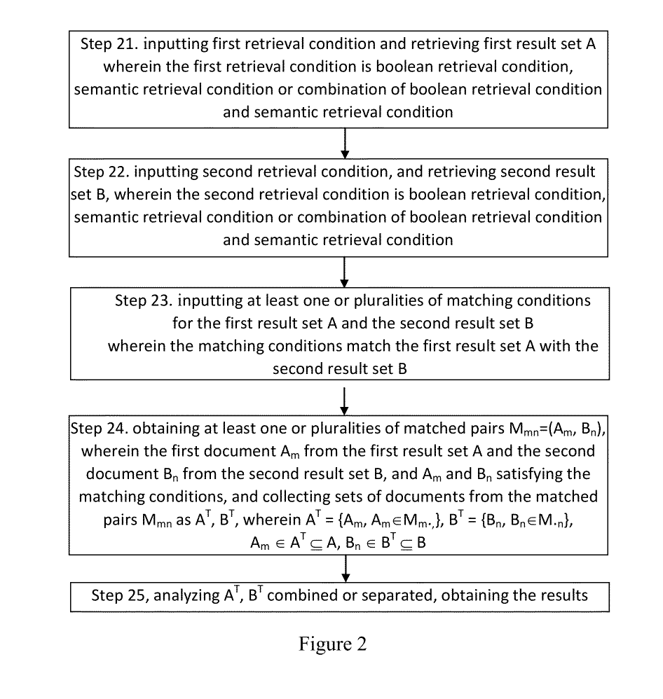

FIG. 2 is the flowchart of the first embodiment based on the present invention for automatically retrieving and analyzing multiple groups of documents {A, B} by mining many-to-many relationships.

Step 21, inputting first retrieval condition and retrieving first result set A, wherein the first retrieval condition is boolean retrieval condition, semantic retrieval condition or combination of boolean retrieval condition and semantic retrieval condition;

step 22, inputting second retrieval condition and retrieving second result set B, wherein the second retrieval condition is boolean retrieval condition, semantic retrieval condition or combination of boolean retrieval condition and semantic retrieval condition;
step 23, inputting at least one or pluralities of matching conditions of the first result set A and the second result set B; wherein the matching conditions match the first result set A with the second result set B;
step 24, based on the first result set A and the second result set B, and at least one or pluralities of matching conditions for the first result set A and the second result set B, obtaining at least one or pluralities of matched pairs Mₘₙ=(Aₘ, Bₙ), wherein the matched pairs Mₘₙ=(Aₘ, Bₙ) comprise of the first document Aₘ and the second document Bₙ, wherein the first document Aₘ is from the first result set A, and the second document Bₙ is from the second result set B, and Aₘ and Bₙ satisfying the matching conditions and collecting sets of documents from the matched pairs Mₘₙ as A^{T}, B^{T}, wherein A^{T}={Aₘ, AₘεMₘ._{,}}, B^{T}={Bₙ, BₙεM.ₙ}, AₘεA^{T} [symbol] A, BₙεB^{T} [symbol] B;
Step 25, analyzing A^{T}, B^{T} combined or separated, obtaining the results.

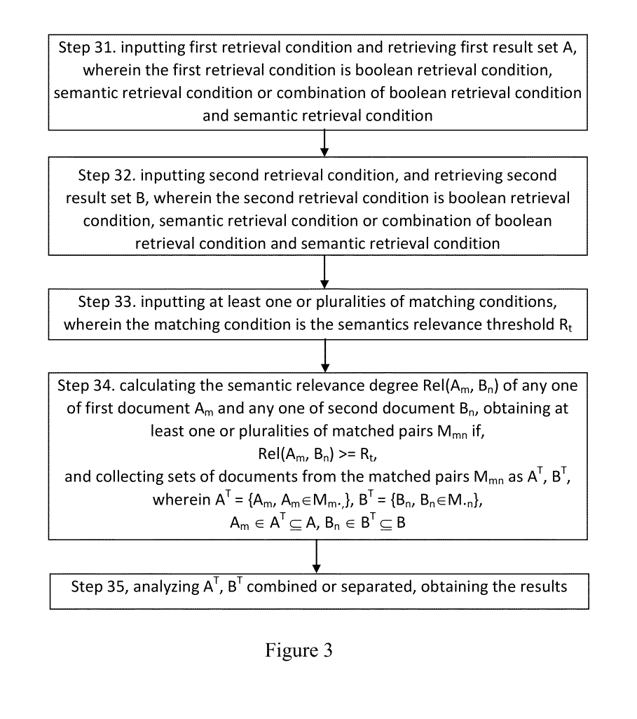

FIG. 3 is the flowchart of the second embodiment of the present invention, comprising a preferred process for automatically retrieving and analyzing multiple groups of documents by mining many-to-many relationships,

Step 31, inputting first retrieval condition and retrieving first result set A, wherein first retrieval condition is boolean retrieval condition, semantic retrieval condition or combination of boolean retrieval condition and semantic retrieval condition;
step 32, inputting second retrieval condition, and retrieving second result set B, wherein second retrieval condition is boolean retrieval condition, semantic retrieval condition or combination of boolean retrieval condition and semantic retrieval condition;
step 33, inputting at least one or pluralities of matching conditions, wherein the matching condition is the semantic relevance threshold Rb wherein the semantics relevance threshold Rₜ is the minimum relevance degree of the match between any one of the first document Aₘ from the first result set A and any one of the second document Bₙ from the second result set B, wherein

Rel(Aₘ,Bₙ)>=Rₜ; (4)

step 34, calculating the semantic relevance degree Rel(Aₘ, Bₙ) of any one of first document Aₘ and any one of second document Bₙ, wherein the first document Aₘ from the first result set A and the second document Bₙ from the second result set B, if the semantic relevance degree Rel(Aₘ, Bₙ) is greater than or equal to the minimum relevance degree Rₜ, the first document Aₘ and the second document Bₙ are defined as a matched pair as (Aₘ, Bₙ), and collecting sets of documents from the matched pairs Mₘₙ as A^{T}, B^{T}, wherein A^{T}={Aₘ, AₘεMₘ._{,}}, B^{T}={Bₙ, BₙεM.ₙ}, AₘεA^{T} [symbol] A, BₙεB^{T} [symbol] B;
step 35, analyzing A^{T}, B^{T} combined or separated and obtaining the results.

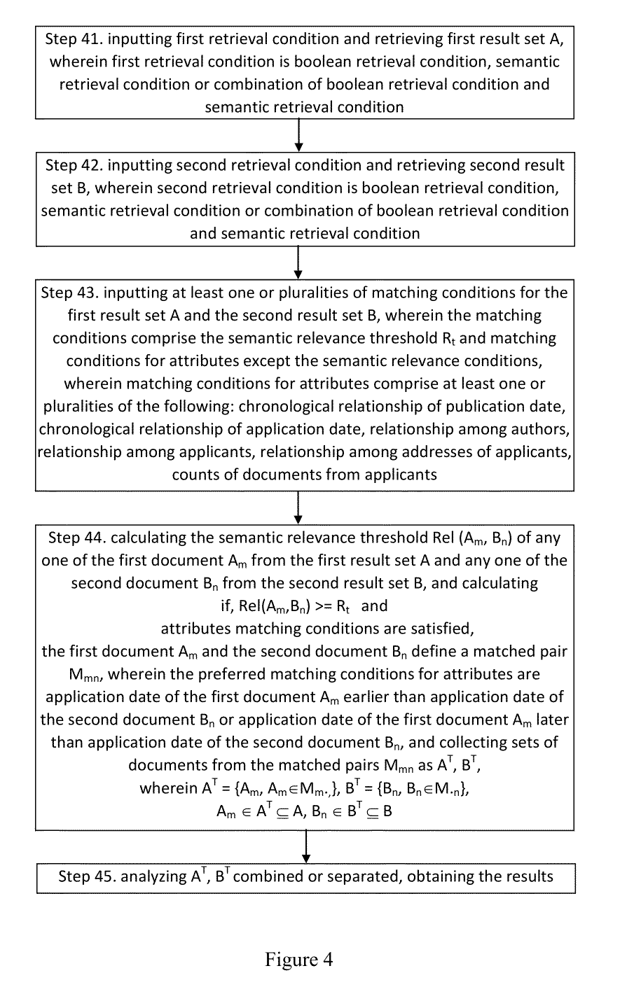

FIG. 4 is a flowchart of the third embodiment based on the present invention, comprising another preferred process for automatically retrieving and analyzing multiple groups of documents by mining many-to-many relationships,

Step 41, inputting first retrieval condition and retrieving first result set A, wherein first retrieval condition is boolean retrieval condition, semantic retrieval condition or combination of boolean retrieval condition and semantic retrieval condition;
step 42, inputting second retrieval condition and retrieving second result set B, wherein second retrieval condition is boolean retrieval condition, semantic retrieval condition or combination of boolean retrieval condition and semantic retrieval condition;
step 43, inputting at least one or pluralities of matching conditions of the first result set A and the second result set B, wherein the matching conditions comprise of the semantic relevance threshold Rₜ and attribute matching condition excluding the semantic relevance conditions, wherein the semantics relevance threshold Rₜ is the minimum relevance degree of the match between the first document Aₘ from the first result set A and the second document Bₙ from the second result set B, wherein the attribute matching condition comprising at least one or pluralities of the following: chronological relationship of publication date, chronological relationship of application date, relationship among authors, relationship among applicants, relationship among addresses of applicants, counts of documents from applicants;
step 44, calculating the semantic relevance threshold Rel (Aₘ, Bₙ) of any one of the first document Aₘ from the first result set A and any one of the second document Bₙ from the second result set B, and calculating if attribute matching conditions are satisfied, if the semantic relevance threshold Rel(Aₘ, Bₙ) is greater than or equal to the minimum relevance degree Rₜ and attribute matching conditions are satisfied, the first document Aₘ and the second document Bₙ define a matched pair as (Aₘ, Bₙ), wherein the preferred attribute matching conditions are application date of the first document Aₘ earlier than application date of the second document Bₙ or application date of the first document Aₘ later than application date of the second document Bₙ, wherein the first document Aₘ from the first result set A and the second document Bₙ from the second result set Bₙ and collecting sets of documents from the matched pairs Mₘₙ as A^{T}, B^{T}, wherein A^{T}={Aₘ, AₘεMₘ._{,}}, B^{T}={Bₙ, BₙεM.ₙ}, AₘεA^{T} [symbol] A, BₙεB^{T} [symbol] B;
step 45, analyzing A^{T}, B^{T} combined or separated, and obtaining the results.

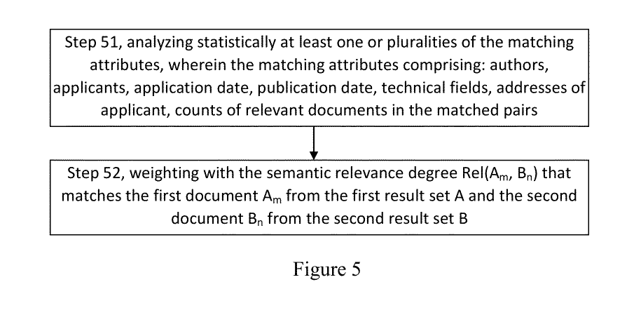

FIG. 5 is the preferred flowchart of step 5 for analyzing matched pairs and obtaining results based on the first and third embodiments of the present invention,

step 51, analyzing statistically at least one or pluralities of the matching attributes, wherein the matching attributes comprising of the following: authors, applicants, application date, publication date, technical fields, addresses of applicant, counts of relevant documents in the matched pairs;
step 52, weighting with the semantic relevance degree Rel(Aₘ, Bₙ) that matches the first document Aₘ from the first result set A and the second document Bₙ from the second result set B, for example, if Rel(Aₘ, Bₙ) is 90%, when counting the other non-semantic matching attributes, multiplied by 0.9.

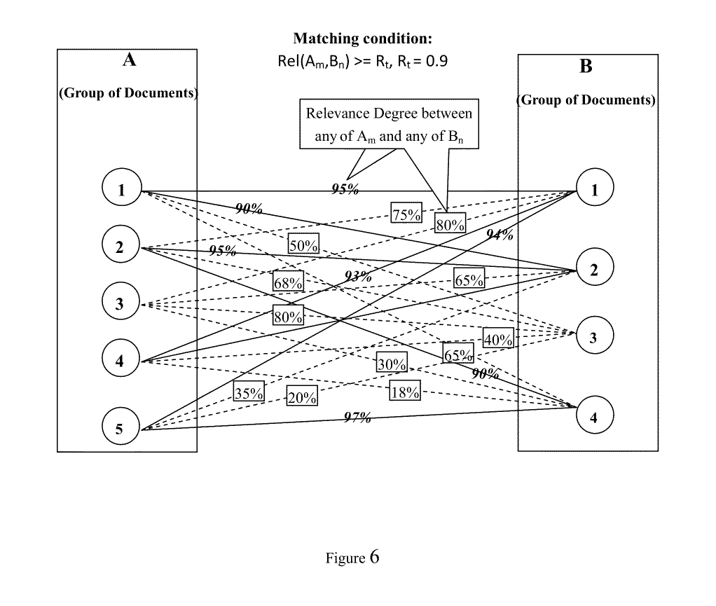

FIG. 6 is an specific application case calculating the semantic relevance degree of any one of first document Aₘ and any one of second document Bₙ based on the present invention, wherein the first document Aₘ is from the first result set A of documents using the first retrieval condition, where A has a total of 5 documents, and the second document Bₙ from the second result set of documents using the second retrieval condition, B has a total of 4 documents, and calculating the semantic relevance degree Rel(Aₘ, Bₙ) for any one of the first document Aₘ from the first result set of documents A and any one of the second document Bₙ from the second result set of documents B.

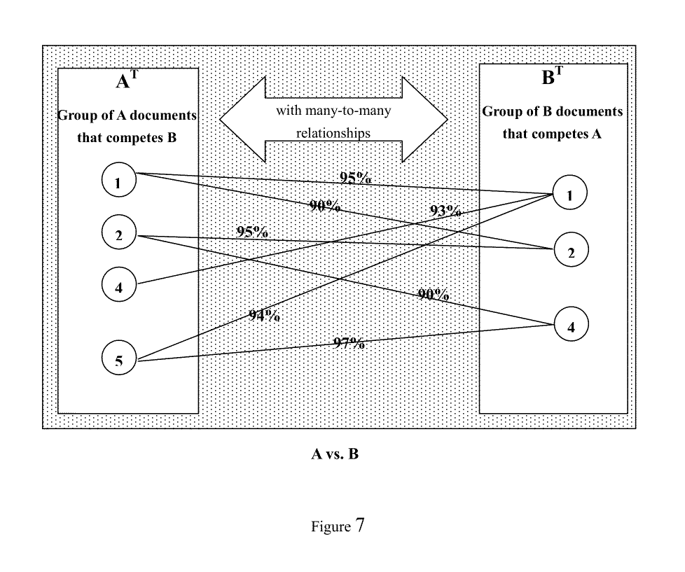

FIG. 7 is the matching results of a specific application case based on the embodiment of the present invention. By inputting 90% as the semantic relevance threshold Rb any pair of documents between the first group of documents A and the second group of documents B having the semantic relevance degree Rel(Aₘ, Bₙ) greater than or equal to 90% is defined as a matched pair.

In the example,

A={A₁,A₂,A₃,A₄,A₅} with counts of 5;

B={B₁,B₂,B₃,B₄} with counts of 4;

The matched pairs between A and B are,

M₁₁=(A₁,B₁),M₁₂=(A₁,B₂),M₂₂=(A₂,B₂),M₂₄=(A₂,B₄),

M₄₁=(A₄,B₁),M₅₁=(A₅,B₁),M₅₄=(A₅,B₄),

Which means the relevance degree Rel(A₁, B₁), Rel(A₁, B₂), Rel(A₂, B₂), Rel(A₂, B₄), Rel(A₄, B₁), and Rel(A₅, B₁), Rel(A₅, B₄) are all greater than or equal to 90%, therefore, 7 pairs above are defined as the matched pairs, and Rel(A₃, Bₙ, n=1,4), which are all less than 90%, are not matched pairs.

Furthermore, counts of A₁ in the matched pairs is 2, so the hit number is 2. Similarly, A₂ hit number is 2, A₄ hit number is 1, A₅ hit number is 2, and obviously, A₃ hit number is 0 that is not relevant (competing) to the second group of documents B and not counted in A^{T};

When A competes against B, its competing document set,

A^{T}={A₁,A₂,A₄,A₅} with counts of 4; (5)

The normalized competition coefficient T_{A} for A competing against B is defined as the ratio of the counts of competing documents and total counts of A,

T_{A}=counts(A^{T})/counts(A); (6)

in this case, T_{A}=⅘;
The matched pairs between B and A are,

M₁₁=(B₁,A₁),M₁₄=(B₁,A₄),M₁₅=(B₁,A₅),M₂₁=(B₂,A₁),

M₂₂=(B₂,A₂),M₄₂=(B₄,A₂),M₄₅=(B₄,A₅)

Which means the relevance degree Rel(B₁, A₁), Rel(B₁, A₄), Rel(B₁, A₅), Rel(B₂, A₁), Rel(B₂, A₂), and Rel(B₄, A₂), Rel(B₄, A₅) are all greater than or equal to 90%, therefore, 7 pairs above are defined as the matched pairs, and Rel(B₃, Aₘ, m=1, 4), which are all less than 90%, are not matched pairs.

Furthermore, counts of B₁ in the matched pairs is 3, so the hit number is 3. Similarly, B₂ hit number is 2, B₄ hit number is 2, and obviously, B₃ hit number is 0 that is not relevant (competing) to the first group of documents A and not counted in B^{T};

When B competes against A, its competing document set,

B^{T}={B₁,B₂,B₄} with counts 3;

The normalized competition coefficient T_{B} for B competing against A is defined as the ratio of the counts of competition documents and total counts of B,

T_{B}=counts(B^{T})/counts(B); (7)

in this case, it is T_{B}=¾;

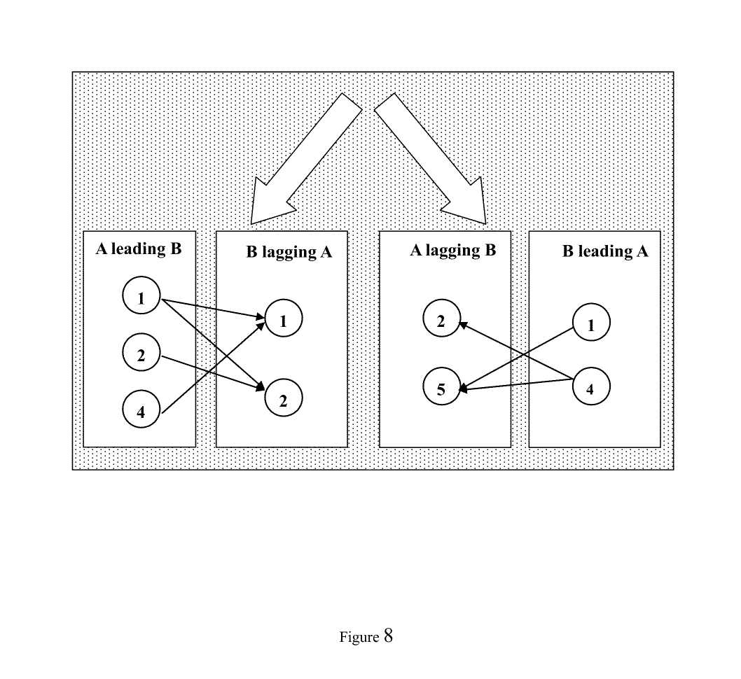

FIG. 8 is an analysis result of a specific application case based on the embodiment of the present invention. Based on chronological application date order among the competing documents, the competing document groups A^{T} and B^{T} can be further partitioned into two subsets. In the example, A^{T}={A₁, A₂, A₄, A₅}, 3 of 4 documents, A^{A}={A₁, A₂, A₄} are applied earlier than documents from B^{T}. This means A₁ is applied earlier than B₁ or B₂ or both, and A₂ is applied earlier than B₂ or B₄ or both, A₄ is applied earlier than B₁. The leading coefficient A^{A} for A is,

L_{A}=counts(A^{A})/counts(A^{T}) (8)

Similarly, B^{T}={B₁, B₂, B₄}, 2 of 3 documents, B^{A}={B₁, B₄} are applied earlier than A^{T}. This means B₁ is earlier than A₁ or A₂ or both, and B₄ is applied earlier than A₁ or A₂ or both. The leading coefficient B^{A} for B is,

L_{B}=counts(B^{A})/counts(B^{T}) (9)

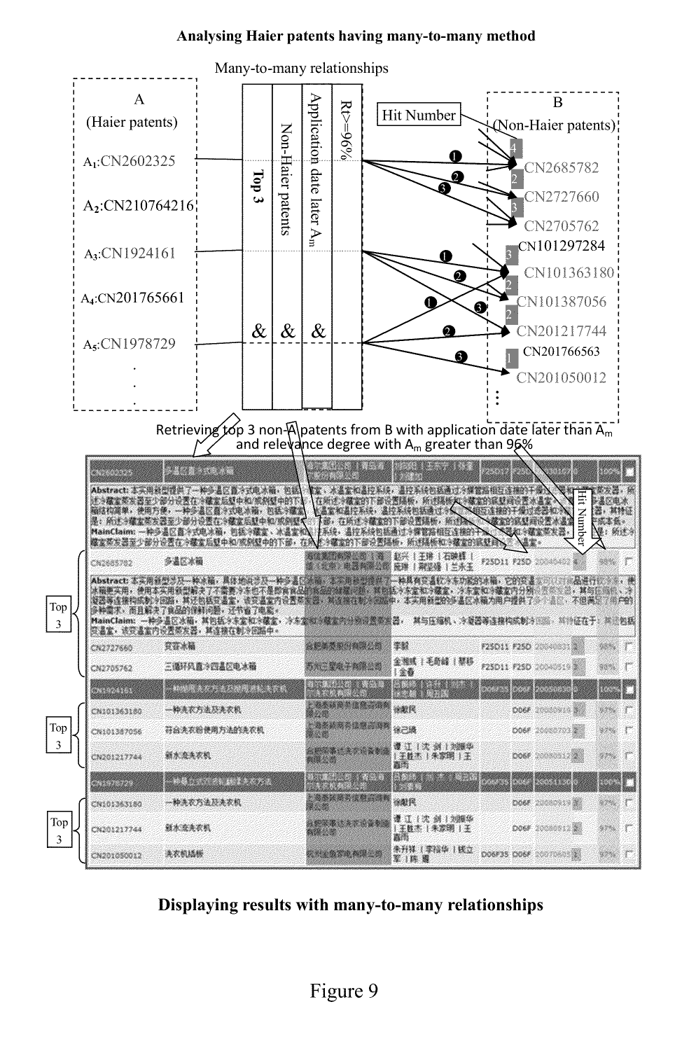

FIG. 9 is a system output of a specific application case based on the present invention embodiment. Matching conditions inputted are computed for every Aₘ from A, retrieving top 3 of non-A patents from B with application date later than Aₘ and relevance degree with Aₘ greater than 96%. In this specific example, A contains all Chinese Patent Applications from Haier Company, a total of 3,865 documents, and B contains all other Chinese Patent Applications excluding Haier, a total of U.S. Pat. No. 4,101,462 documents. Based on the matching conditions inputted, one of the embodiment for the present invention, automatically identifies Haier Patent Application Publication No. CN2602365, titled “multi-temperature direct-cool refrigerator”, with application date 2003/01/07, relevant (competing) with three other non-Haier applications, CN2685782, CN2727660, CN2705762 with relevance degree 98%, 98% and 98% respectively.

Moreover, the application date for the three patent applications (2004/04/02, 2004/08/31, 2004/05/19) are all applied after 2003/01/07. It also computes the hit counts of the three non-Haier patent applications as 4, 2, 3. In this example, it points CN2685782 as relevant to and lagging CN2602365 and three other Haier patent applications; CN2727660 as relevant to and lagging CN2602365 and one other Haier patent application; and CN2705762 as relevant to and lagging CN2602365 and two other Haier patent applications. From this analytical point of view, this is noteworthy.

Although the embodiments of the present invention have been described in detail, many modifications and variations may be made by a person skilled in the art from the disclosed herein above. Therefore, it should be understood that any modification and variation equivalent to the spirit of the present invention be regarded to fall within the scope as defined by the appended claims.

1. A method for automatically retrieving and analyzing multiple groups of documents by mining many-to-many relationships comprising of:
Step 1, inputting first retrieval condition and retrieving first result set A;
Step 2, inputting second retrieval condition and retrieving second result set B;
Step 3, inputting at least one or pluralities of matching conditions for the first result set A and the second result set B;
Step 4, obtaining at least one or pluralities of matched pairs Mₘₙ=(Aₘ, Bₙ), wherein the matched pairs Mₘₙ=(Aₘ, Bₙ) comprise of the first document Aₘ from the first result set A and the second document Bₙ from the second result set B, and Aₘ and Bₙ satisfying the matching conditions, and collecting documents from the matched pairs Mₘₙ as A^{T}, B^{T};
Step 5, analyzing A^{T}, B^{T} and obtaining the results.

2. The method of claim 1, wherein the step 3 further comprising the sub-step of: inputting a semantic relevance threshold Rₜ, wherein the semantics relevance threshold Rₜ is the minimum relevance degree of the match between the first document Aₘ from the first result set A and the second document Bₙ from the second result set B, wherein
Rel(Aₘ,Bₙ)>=Rₜ (1)

3. The method of claim 1, wherein the step 3 further comprising the sub-step of: inputting matching attributes, wherein the matching attributes match the first document Aₘ from the first result set A and the second document Bₙ from the second result set B.

4. The method of claim 3, wherein the matching attributes comprise of at least one or pluralities of the following: chronological relationship of publication date, chronological relationship of application date, relationship among authors, relationship among applicants, relationship among addresses of applicants, or number of documents from applicants.

5. The method of claim 4, wherein the step 5 further comprising the sub-step of: statistically analyzing at least one or pluralities of the matched attributes that comprise of document authors, applicants, application date, publication date, technology fields, applicant addresses, or count of relevant documents in the matched pairs.

6. The method of claim 5, wherein the step 5 further comprising the sub-step of: weighting the semantic relevance degree Rel(Aₘ, Bₙ) matching the first document Aₘ from the first result set A and the second document Bₙ from the second result set B.

7. The method of claim 1, wherein the step 5 further comprising the sub-step of analyzing A^{T} and B^{T} combined.

8. The method of claim 1, wherein the step 5 further comprising the sub-step of analyzing A^{T} and B^{T} separated.

9. The method of claim 1, wherein the first retrieval condition and the second retrieval condition comprising: boolean retrieval condition, semantic retrieval condition or combination of boolean retrieval condition and semantic retrieval condition.

10. A system for automatically retrieving and analyzing multiple groups of documents by mining many-to-many relationships comprising of:
a device for inputting first retrieval condition and retrieving first result set A;
a device for inputting second retrieval condition and retrieving second result set B;
a device for inputting at least one or pluralities of matching conditions for the first result set A and the second result set B;
a device for obtaining at least one or pluralities of matched pairs Mₘₙ=(Aₘ, Bₙ), wherein the matched pairs Mₘₙ=(Aₘ, Bₙ) comprise of the first document Aₘ from the first result set A and the second document Bₙ from the second result set B, and Aₘ and Bₙ satisfying the matching conditions, and collecting documents from the matched pairs Mₘₙ as A^{T}, B^{T};
a device for analyzing A^{T}, B^{T}, and obtaining the results.

11. The system of claim 10, wherein the device for inputting at least one or pluralities of matching conditions for the first result set A and the second result set B, further comprising the sub-unit of: a device for inputting semantic relevance threshold Rₜ, wherein the semantics relevance threshold Rₜ is the minimum relevance degree of the match between the first document Aₘ from the first result set A and the second document Bₙ from the second result set B, wherein
Rel(Aₘ,Bₙ)>=Rₜ (2)

12. The system of claim 10, wherein the device for inputting at least one or pluralities of matching conditions for the first result set A and the second result set B, further comprising the sub-unit of: a device for inputting matching attributes, wherein the matching attributes match the first document Aₘ from the first result set A and the second document Bₙ from the second result set B.

13. The system of claim 10, wherein the matching attributes comprise of at least one or pluralities of the following: chronological relationship of publication date, chronological relationship of application date, relationship among authors, relationship among applicants, relationship among addresses of applicants, or number of documents from applicants.

14. The system of claim 13, wherein the device for analyzing at least one or pluralities of matched pairs Mₘₙ=(Aₘ, Bₙ) and obtaining results, comprising: statistically analyzing at least one or pluralities of the matching attributes based on at least one or pluralities of the document attributes comprising of: authors, applicants, application date, publication date, technology fields, applicant addresses, or count of relevant documents in the matched pairs.

15. The system of claim 14, wherein the device for analyzing A^{T}, B^{T}, and obtaining the results further comprising the sub-unit of: weighting the semantic relevance degree Rel(Aₘ, Bₙ) matching the first document Aₘ from the first result set A and the second document Bₙ from the second result set B.

16. The system of claim 10, wherein the device for analyzing A^{T}, B^{T} and obtaining the results further comprising the sub-unit of analyzing A^{T} and B^{T} combined.

16. The system of claim 10, wherein the device for analyzing A^{T}, B^{T} and obtaining the results further comprising the sub-unit of analyzing A^{T} and B^{T} separated.

18. The system of claim 8, wherein the device for inputting first retrieval condition and the second retrieval condition further comprising the sub-unit of: a device inputting boolean retrieval condition, semantic retrieval condition or combination of boolean retrieval condition and semantic retrieval condition.

19. A computer storage medium encoded with a computer program, the computer program comprising instructions that when executed cause a computer to perform operations comprising: inputting first retrieval condition and retrieving first result set A; inputting second retrieval condition and retrieving second result set B; inputting at least one or pluralities of matching conditions for the first result set A and the second result set B; obtaining at least one or pluralities of matched pairs Mₘₙ=(Aₘ, Bₙ), wherein the matched pairs Mₘₙ=(Aₘ, Bₙ) comprise of the first document Aₘ from the first result set A and the second document Bₙ from the second result set B, and Aₘ and Bₙ satisfying the matching conditions, and collecting documents from the matched pairs Mₘₙ as A^{T}, B^{T}; analyzing A^{T}, B^{T} combined or separated, and obtaining the results.
